(19) United States
(12) Patent Application Publication
(10) Pub. No.: US 2015/0244520 A1
(43) Pub. Date: Aug. 27, 2015

(54) ONE-TIME-PAD DATA ENCRYPTION WITH MEDIA SERVER

(71) Applicant: Alexander Kariman, Rockville, MD (US)

(72) Inventors: Alexander V Kariman, Rockville, MD (US); Andrew V Bardachenko, Obuhov (UA)

(73) Assignee: SAFE FRONTIER LLC, McLean, VA (US)

(21) Appl. No.: 14/187,107

(22) Filed: Feb. 21, 2014

(51) Int. Cl. H04L 9/08; H04L 9/32

(52) U.S. Cl. CPC H04L 9/0863; H04L 9/3242; H04L 2209/24

(57) ABSTRACT

The disclosed invention in essence relates to protection of information in communication channels between a sender and a communication server and a communication server and a receiver, and wherein a Vernam cypher and one time pad personal encryption keys of a sender and a receiver are used for encrypting transmitted data.

### FIELD OF INVENTION

This invention relates to encryption of data transmitted in communication channels between a data sender and a data receiver, using a media server; specifically, using a Vernam cipher that under certain conditions provides absolute cryptographic stability of the encrypted data.

### BACKGROUND

There are many known methods used for cryptographic data protection, whether the data is in-rest or in-flight. The method of protecting digital information disclosed herein uses One-Time-Pad encryption based on the Vernam cipher. This method features absolute cryptographic stability under certain conditions

One-time-pad (OTP) was patented in 1919 (US Pat. No. 11,310,719). Because it involves a random key character used to encrypt each character of plaintext, there is no information in the cipher-text on which to use cryptanalysis. The number of possible keys approaches infinity and even if some of them were guessed and operated on the cipher-text to produce meaningful plaintext, there would be no way to know which of the multitude of plaintexts rendered was the intended one.

Vernam cipher is the only known system that is mathematically proven to provide absolute cryptographic stability; e.g., intercepted encrypted data provides no information about the message. From the cryptography point of view, it is impossible to attain a system more secure than Vernam cipher. However, implementation of such system is not a trivial task, since it requires a truly random one-time-pad encryption key to be equal in size to the size of a message to be encrypted, followed by a guaranteed destruction of such key on the encrypting/decrypting device. Therefore, a commercial implementation of the Vernam cipher is very limited, unlike the use of public key-based and other common asymmetric and symmetric encryption systems.

Vernam cipher is one of the simplest and least demanding cyphers, which makes possible using such cypher on almost any electronic device. In order to generate a cipher-text, plain text (any digital data) is combined using “exclusive OR” (XOR) operation with an encryption key (called “one-time-pad” or “cipher-pad” or “gamma”). However, the key must demonstrate three critical properties:
1. Have uniformly random distribution;
2. Be equal in size with a message to be encrypted;
3. Be used only once.

There is also a fourth, not so obvious requirement, where one-time-pad key must be destroyed immediately after use.

Vernam encryption is rarely because modern cryptography techniques are sufficiently developed. However, the technological advancement in crypto-analysis and increase of computing power increases the probability of successful attacks on sophisticated ciphers.

Modern storage media can now store large amount of random key data, and random number generators can produce sufficient quality random key material for use with a Vernam cipher. All these factors now make Vernam cipher a more attractive option.

As a practical matter, it is also possible to physically transfer a storage medium with sufficient amount of truly random key material necessary to encrypt messages. In fact, cipher-pads are based on this principle: a notepad containing pages with key material is transported via diplomatic mail or in person. The same notepad is present at a receiving side. Used pages are then destroyed.

In order for Vernam cipher to work, it requires a truly random encryption key. Encryption key material obtained using any mathematical algorithm is not truly random, but pseudo-random. Therefore, it is necessary to obtain a random sequence not algorithmically (for example, using white noise—radioactive decay, or other somewhat random events). In order to make the distribution fairly close to uniform, random sequence is typically processed using a hash function, such as an MD5.

The disadvantage of using the Vernam cipher is the lack of authentication and message integrity. The recipient cannot verify if the message was modified or verify the authenticity of a sender. If a third party intercepts a message, knowing the message plain-text, it is possible to restore the one-time-pad key used to encrypt such message, and such party would be able to replace the original message with a spoofed message of the same length. One option is to use a hash function (check-sum). In one exemplary embodiment, a hash function may be computed from a plain-text, and its value is encrypted together with a message. If the message is changed, the hash value will also change. Thus, even if an attacker obtains a cipher-pad, without the knowledge of hash algorithm, an attacker cannot use it to spoof a message.

A variety of OTP-based systems are known. For example, as described in the U.S. Pat. No. 8,467,533 B2 (Publication date Jun. 18, 2013), in essence there is a one-time-pad encryption system where encrypted one-time-pad keys can be distributed to users on physical media or via a computer network from a central server. Another disclosure, PCT/US Application No. 1999/014224 (Publication date Nov. 16, 2000) comprises of a method for generating an identical electronic one-time-pad at a first and second locations. Each location is provided an electronic device, said electronic devices containing identical tables of true random numbers. Another invention described in the U.S. Pat. No. 8,050,405 B2 (Publication date Nov. 1, 2011), in essence comprises of methods for securely communicating a message from a first terminal to a second terminal, and includes generating a keypad including a random sequence of bits having a length, encrypting the message at the first terminal using a bit string beginning at an offset in the keypad, and transmitting the encrypted message and an indicator of the offset to the second terminal. Another invention described in the U.S. Pat. No. 6,363,152 B1 (Publication date Mar. 26, 2002), in essence describes a hybrid one time pad encryption and decryption apparatus with methods for encrypting and decrypting data wherein a one-time random number pad provides high security encryption. Another disclosure, U.S. application Ser. No. 10/809,889 (Publication date Oct. 28, 2004) in essence comprises of an IM server providing instant message service to a communication device, a first client terminal, and a second client terminal, however it does not provide information encryption. Another invention described in the U.S. Pat. No. 8,050,405 B2 (Publication date Sep. 30, 2005), in essence describes methods of securely communicating a message from a first terminal to a second terminal include generating a keypad including a random sequence of bits having a length L, encrypting a message at the first terminal using a bit string beginning at an offset O in the keypad, and transmitting the encrypted message and an indicator of the offset O to the second terminal.

### SUMMARY

The disclosed herein invention fulfills the aforementioned Vernam cipher requirements and therefore provides absolute cryptographic stability of encrypted data.

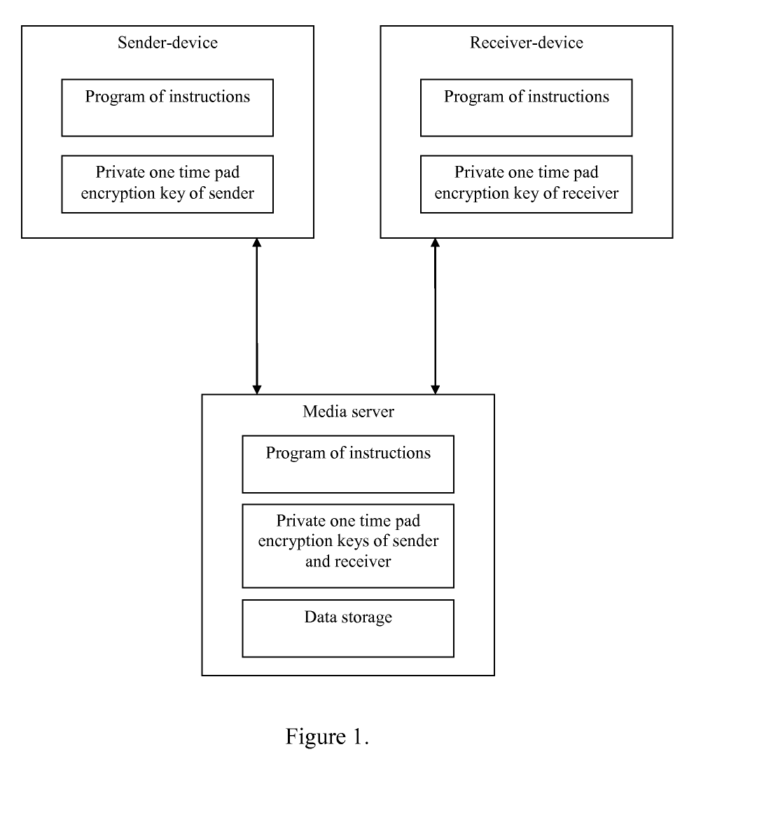

In one exemplary embodiment, the transmitted data is encrypted using one time pad personal encryption keys of a sender-device and a receiver-device, and the encryption key is the same size as the transmitted data. However, neither data nor the data encryption keys are transmitted directly between a sender-device and a receiver-device. The encrypted data is transmitted from a sender-device to a media server and from a media server to a receiver-device. The media server though, contains one time pad personal encryption keys of a sender-device and a receiver-device that are used to encrypt the transmitted data. FIG. 1 shows an example of one such embodiment of the disclosure among many other possible embodiments.

### DETAILED DESCRIPTION

The following description and the referrals to the accompanying drawings show, by way of illustration, specific details and aspects of this disclosure in which the invention may be practiced. The word “exemplary” is used herein to mean “serving as an example, instance, or illustration”. Any aspect of this disclosure described herein is not necessarily to be construed as preferred or advantageous over other aspects of this disclosure or designs unless expressly stated. The term “circuit” (or “circuitry”) may be understood as any kind of logic implementing entity, which may be hardware (in some exemplary embodiment, including silicon), software, firmware, or any combination thereof. Thus, a “circuit” may be a hard-wired logic circuit or a programmable logic circuit such as a programmable processor, e.g. a microprocessor. A “circuit” may also be software being implemented or executed by a processor, e.g. any kind of computer program. Any other kind of implementation of the respective functions described herein may also be understood as a “circuit” or “circuitry”. The terms “coupling” or “connection” are intended to include a direct “coupling” or direct “connection” as well as an indirect “coupling” or indirect “connection” respectively. A “network” may be understood any physical and logical network, including Internet network, local network, wireless or wired network, etc. A “media server” may be understood as a server, a gateway, a proxy, a database, an electronic device, a device communicating over wired or wireless network, a device having electronic circuitry. A “device” or “electronic device” may be understood as any circuitry. A “sender-device” or “sender” may be understood to be a circuitry that sends using a communications interface at least one data packet. A “receiver-device” or “receiver” may be understood to be a circuitry that receives using a communications interface at least one data packet. A “message” may be understood as at least one data packet sent or received using a communication interface of an electronic device. A “Random Number Generator (RNG)” may be understood to include software RNG, firmware RNG, hardware RNG, and any circuitry capable of generating a random or pseudorandom bit sequence. A “hash function” may be understood to include any algorithm that maps data of arbitrary length to data of a fixed length.

In one exemplary embodiment, the random uniform distribution of a personal encryption key may be achieved using known software, hardware, and/or firmware devices, such as a Random Number Generator (RNG) that generates a sequences of random numbers with fairly random and uniform distribution, sufficient for a one-time-pad encryption key. In one exemplary embodiment, the generated one time pad encryption key may be stored in a database of a media server, as well as delivered to a sender-device and a receiver-device. Such keys may be distributed, for example, using a physically delivered removable data storage media, or any separate communication means established between plurality of media servers and plurality of senders and receivers.

In one exemplary embodiment, the equality of size of a one time pad encryption key and encrypted data may be attained as follows. A program of instructions coupled with a sender-device determines a message size prior to sending a message. Such program then obtains from a data storage coupled with a sender-device, a personal one time pad encryption key that is the same size as a message to be transmitted. Next, the program encrypts a transmitted message using a Vernam cipher, e.g., where XOR operation is applied to each bit of a message, where the second operand is a corresponding bit (starting with the first bit) of a part of a personal one time pad encryption key of a sender-device.

In one exemplary embodiment, in order to control integrity of a transmitted encrypted message, a check-sum can be computed by a sender-device prior to encrypting a message by way of applying a hash function, for example an MD5. Thus, if a message is intercepted and spoofed, the check-sum, calculated after decrypting a message, will be incorrect and a media server may be able to conclude that the message was altered during delivery.

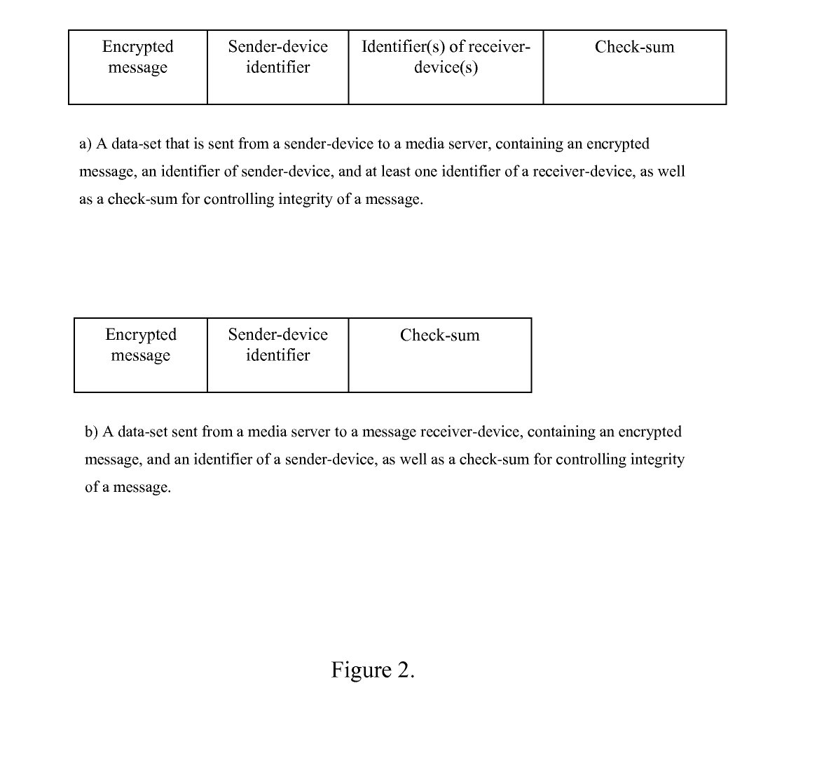

After a check-sum is calculated and a message is encrypted, such data may be transmitted (FIG. 2) to a media server via an open communication channel.

In one exemplary embodiment, each sender and receiver device has an identifier within the system, and therefore a media server can identify a sender and a receiver using identifiers transmitted with a message data (FIG. 2). After a media server identifies a message sender-device, it may use a part of a personal one-time pad encryption key of such sender-device to decrypt a message, where such part equals in size to a received message.

Once a part of such personal one-time-pad encryption key is used, this part is destroyed on a sender-device, as well as on a media server; thus fulfilling both the third requirement (the encryption key is used only once) and the fourth requirement (the encryption key is destroyed immediately after use) of the Vernam cipher.

In one exemplary embodiment, after decrypting a message, a media server verifies the message integrity and identifies a message receiver using an identifier of such receiver received with a message data.

In one exemplary embodiment, if a receiver-device is connected to a media server or a communication channel between a media server and a receiver device is available, the media server may immediately transmit a message to a receiver-device. In another exemplary embodiment, if there is no communication channel with a receiver-device, a media server may store a message in order to deliver a message to a receiver-device once such communication channel is available.

In one exemplary embodiment, in order to encrypt a message before sending it to a receiver-device, a media server retrieves from a storage of personal one time pad encryption keys, a part of a receiver-device personal one time pad encryption key that equals in size to the size of a transmitted message.

Further, a media server encrypts a message using a Vernam cipher, e.g. XOR operation is applied to each bit of a message, where the second operand is a corresponding bit (starting with the first bit) of a part of a personal one time pad encryption key of a receiver-device.

In one exemplary embodiment, in order to ensure integrity of a transmitted encrypted message, a media server may transmit a check-sum computed prior to encrypting a message, using a hash function, for example an MD5. Thus, if a message is intercepted and spoofed, the check-sum, calculated after decrypting a message, will be incorrect, and a recipient of a message may conclude that the message was altered during delivery.

In one exemplary embodiment, upon receiving a message from a media server, a program of instructions coupled with a receiver-device determines a message size. Next, the program of instructions obtains a part of a personal one time pad encryption key from a storage coupled with a receiver-device. Next, the message is decrypted by applying XOR operation to each bit of the message, where the second operand is a corresponding bit (starting with the first bit) of a part of a personal one time pad encryption key of a receiver-device.

In another exemplary embodiment, a message receiver-device may verify a check-sum of a received message by applying a hash function to a decrypted message and comparing the result of this function with a check-sum received with a message transmitted by a media server. If the check-sum matches, a message recipient may conclude that the message received from a media server was not modified during delivery.

Next, the used part of a personal one time pad encryption key is destroyed on a receiver-device; therefore fulfilling both the third requirement (the encryption key is used only once) and the fourth requirement (the encryption key is destroyed immediately after use) of the Vernam cipher.

Thus, all parts of the system meet all four requirements of the OTP encryption.

It should be noted that for proper execution of the fourth requirement (removal of used keys), hardware and software-based methods may be used that guarantee information destruction in nonvolatile and/or volatile memory of the electronic device and/or all coupled data storage devices.

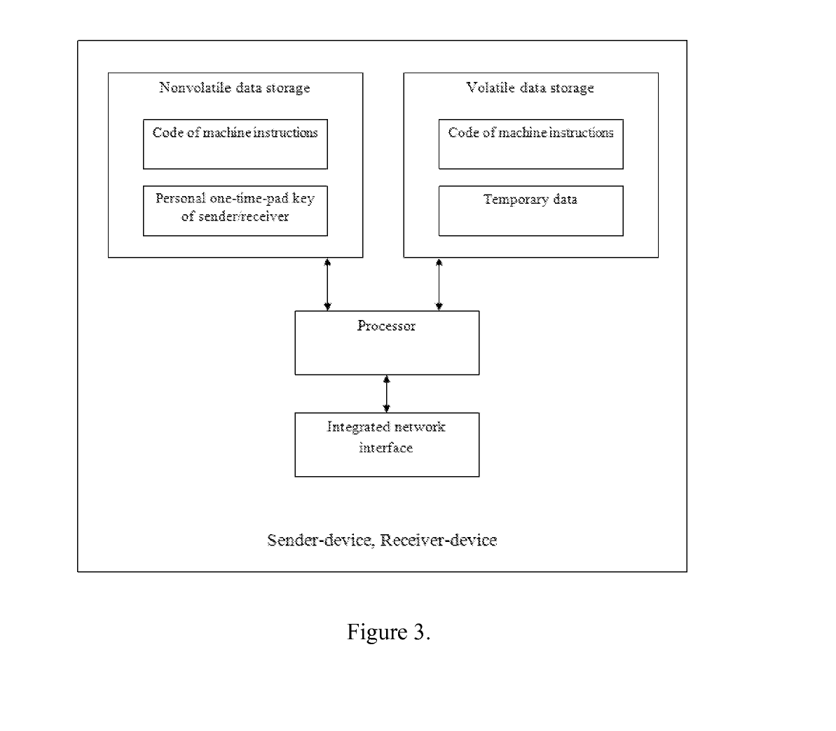

FIGS. 3-6 illustrate some exemplary embodiments of sender and receiver devices.

FIG. 1 illustrates in one exemplary embodiment a sender device exchanging messages with a receiver device via a media server. FIG. 2 illustrates in one exemplary embodiment a data-set structure sent from a sender-device to a media server and from a media server to a message receiver-device. FIG. 3 illustrates in one exemplary embodiment an integrated solution, where all the relevant components pertaining to the sender device and receiver device of the OTP system are located inside the device enclosure. In another exemplary embodiment, system components may be located in a device circuitry.

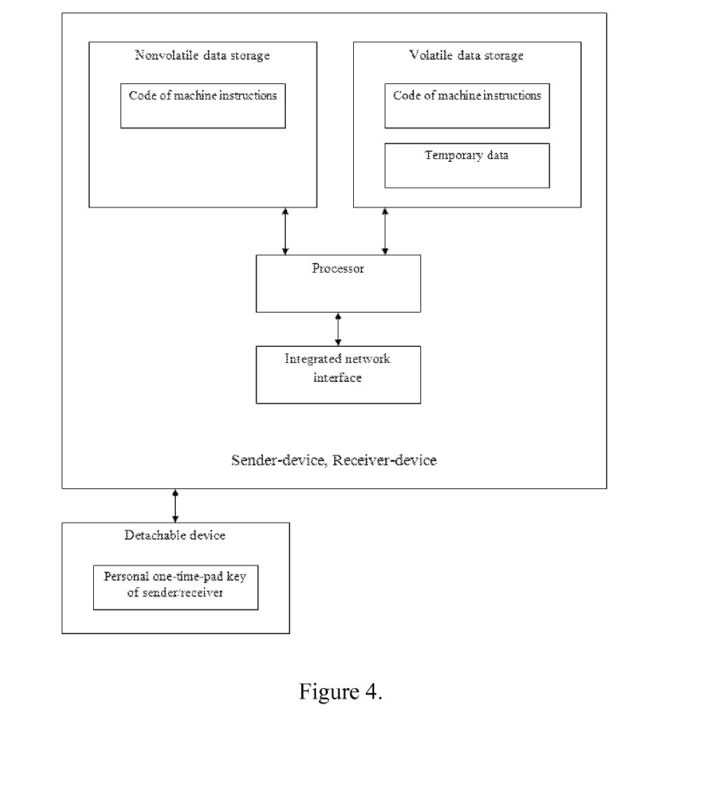

FIG. 4 illustrates in one exemplary embodiment, where a detachable device can be utilized to store a personal one-time-pad key. In this case, as long as the device user does not connect a detachable device that stores a personal one time pad key, the message cannot be decrypted. Also, this method is applicable when a user employs multiple electronic devices. A user can send and receive messages from different devices by connecting a detachable device containing personal one-time-pad key to various sender/receiver devices. In one exemplary embodiment, such devices could be a personal computer, a tablet, a smart phone, an embedded device, a hand-held device coupled with a radio module, a concealed device, a device having an electronic circuitry, and the like. Also, this method allows a user to delegate powers to another user, by providing the other user with a detachable device containing a personal one-time-pad key.

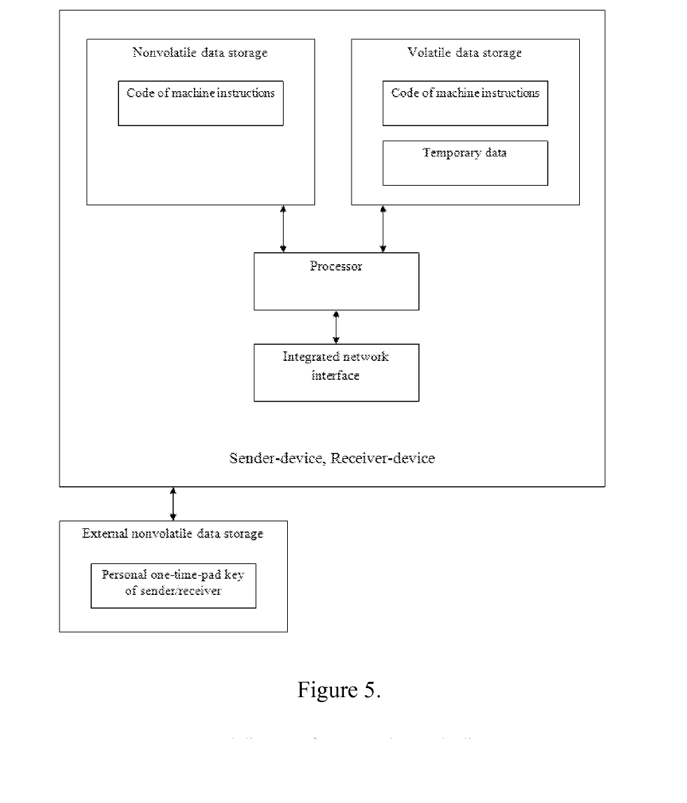

FIG. 5 illustrates in one exemplary embodiment, a device with connected external data storage, such as an external hard-drive. This method can be used to store very large private one time pad keys. Also, this approach allows decentralization, where in case of theft, there are two devices would be required to decrypt a message-the receiver/sender device itself and a detachable personal one time pad key storage device.

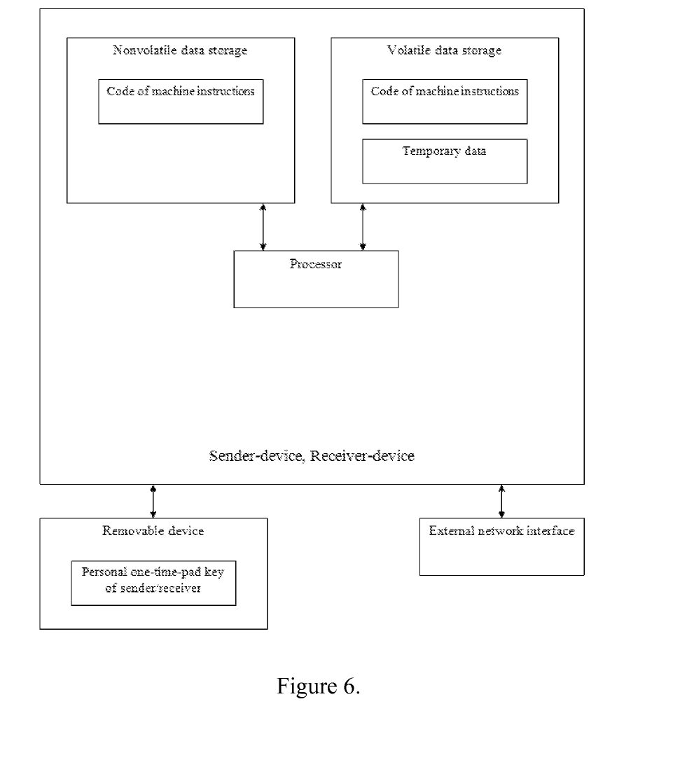

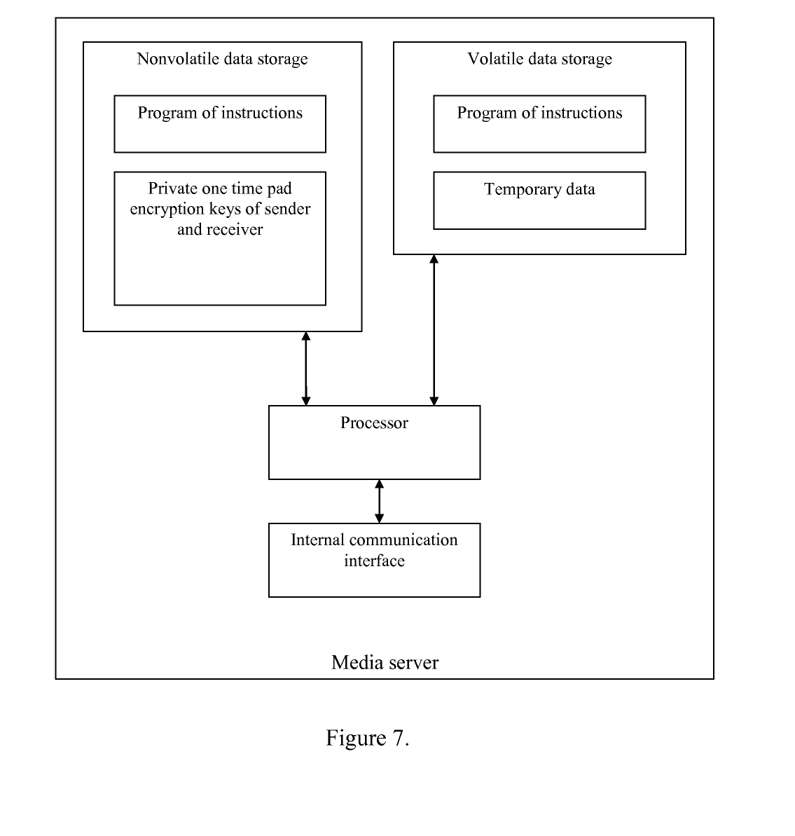

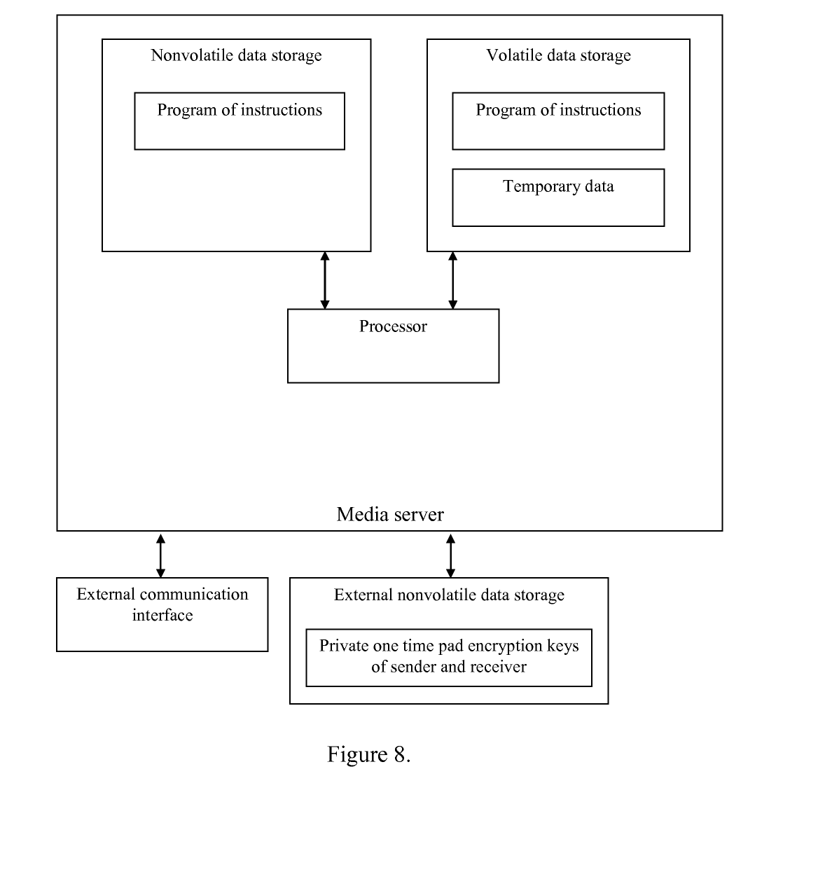

FIG. 6 illustrates an exemplary embodiment of a device communicatively coupled with an external network device. For example, an external WiFi network card that can be connected to a device, and/or a GSM, and/or other transceiver, wherein the device can communicate with a media server via one or more available network interfaces. FIG. 7 illustrates an exemplary embodiment of a media server operably coupled with a network interface and nonvolatile data storage for storing private one time pad encryption keys of sender and receiver. FIG. 8 illustrates an exemplary embodiment of a media server communicatively coupled with an external network interface and an external nonvolatile data storage for storing private one-time-pad encryption keys of sender and receiver.

In another exemplary embodiment, the described herein methods can be utilized to enable OTP encrypted communication between multiple sender/receiver devices, such as enabling OTP encrypted video/audio conferencing, email exchange, file exchange, standard multi-party digitized telephone voice communications, etc. In another exemplary embodiment, such methods and apparatuses can be used to exchange messages utilizing push and pull network communication technologies, including but not limited to unicasting, multicasting, and broadcasting messages, such as SMS, Instant Messages, and the like. In another exemplary embodiment, such communication may be enabled via wired and wireless networks and via any number and any kind of gateways and proxies. In another exemplary embodiment, there could be any number of media servers and they can be geographically distributed. In another exemplary embodiment, any type of communication channel may be encrypted using the disclosed herein methods, e.g., end-to-end communication tunnels, publish/subscribe protocols-based communications, TCP/UDP-based communications, as well as non-TCP communications. The disclosed herein encryption methods can also be used in addition to any other data protection technology, such as TLS/SSL and the like.

FIGS. 7 and 8 illustrate some exemplary embodiments of media server.

The present invention allows implementing one time pad data encryption in the communication channels, using a media server for storing and exchanging messages, where such system confirms to all OTP encryption system characteristics:
1. One-time-pad keys have uniformly random distribution;
2. One-time-pad keys are the same size as the data to be encrypted;
3. One-time-pad keys are used only once;
4. One-time-pad keys are destroyed after use.

Of course, many exemplary variations may be practiced with regard to establishing such interaction. The features disclosed in the foregoing description, or the following claims, or the accompanying drawings, expressed in their specific forms or in terms of a means for performing the disclosed function, or a method or process for attaining the disclosed result, as appropriate, may separately, or in any combination of such features, be utilized for realizing the invention in diverse forms thereof.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What claimed is:

1. Method comprising of a program of instructions coupled with a sender-device, including the following steps:
(a) encrypting at least one message to be transmitted to at least one media server, using bitwise XOR operation to be applied to each bit of a message, wherein the second operand is the appropriate consecutive bit (starting the first bit) of a personal one-time-pad encryption key of a message sender-device; and
(b) sending a data-set to at least one media server, containing an encrypted message, and a sender-device identifier, and at least one identifier of a message receiver-device; and
(c) destroying a part of a personal one-time-pad encryption key used to encrypt a message, wherein such part equals in size to an encrypted message.

2. Method according to claim 1, wherein prior to encrypting a transmitted message, a check-sum is calculated using a hash function, wherein the variable is at least one of: the unencrypted message data, and an identifier of a sender-device, and an identifier of a receiver-device.

3. Method according to claim 1, wherein at least some data-set transmitted to a media server contains a check-sum that is a result of performing a hash operation, wherein the variable is at least one of: unencrypted message data, and an identifier of a sender-device, and an identifier of a receiver-device.

4. Method comprising of a program of instructions coupled with a receiver-device, including the following steps:
(a) receiving a data-set from one or more media servers, containing an encrypted message and a sender-device identifier; and
(b) decrypting a received message, using bitwise XOR operation to be applied to each bit of a message, wherein the second operand is the appropriate consecutive bit (starting the first bit) of a personal one-time-pad encryption key of a message receiver-device; and
(c) destroying a part of a personal one-time-pad encryption key used to decrypt a message, wherein such part equals in size to a message received from a media server.

5. Method according to claim 4, wherein at least some data-set received from a media server contains a check-sum that is a result of performing a hash operation, wherein the variable is at least one of: unencrypted message data, and an identifier of a sender-device.

6. Method according to claim 4, wherein after decrypting a message received in a data-set from a media server, an integrity check of such message is performed by comparing a check-sum, received in such data-set with a check-sum that is a result of performing a hash operation, wherein the variable is an unencrypted message data and/or an identifier of a sender-device.

7. Method comprising of a program of instructions coupled with a media server communicating with one or more sender-devices, including the following steps:
(a) receiving from at least one sender-device a data-set containing an encrypted message, and a sender-device identifier, and a receiver-device identifier; and
(b) identifying a sender-device using a sender-device identifier received in a data-set sent from a sender-device; and
(c) obtaining from a data storage a personal one time pad encryption key of a sender-device that is the same size as a received message; and
(d) decrypting a received message, using bitwise XOR operation to be applied to each bit of a message, wherein the second operand is the appropriate consecutive bit (starting the first bit) of a personal one-time-pad encryption key of a message sender-device; and
(e) destroying a part of a personal one-time-pad encryption key of a sender-device that was used to decrypt a message, wherein such part equals in size to a received message.

8. Method according to claim 7, wherein a program of instructions saves at least one of: a decrypted message, and an identifier of a message sender-device, and an identifier of a message receiver-device.

9. Method according to claim 7, wherein at least some data-set received from a sender-device contains a check-sum that is a result of performing a hash operation, wherein the variable is at least one of: unencrypted message data, and an identifier of a sender-device, and an identifier of a receiver-device.

10. Method according to claim 7, wherein after decrypting a message received in a data-set from a sender-device, an integrity check of such message is performed by comparing a check-sum, received in a data-set with a check-sum that is a result of performing a hash operation, wherein the variable is at least one of: unencrypted message data, and an identifier of a sender-device, and an identifier of a receiver device.

11. Method comprising of a program of instructions coupled with a media server communicating with one or more receiver-devices, including the following steps:
(a) identifying a receiver-device using at least one receiver-device identifier stored on a media server; and
(b) obtaining from a data storage a personal one time pad encryption key of a receiver-device that is the same size as a message; and
(c) encrypting a message, using bitwise XOR operation to be applied to each bit of a message, wherein the second operand is the appropriate consecutive bit (starting the first bit) of a personal one-time-pad encryption key of a message receiver-device; and
(d) transmitting to a receiver-device a data-set containing at least some part of an encrypted message and an identifier of a sender-device; and
(e) destroying a part of a personal one-time-pad encryption key of a receiver-device that was used to encrypt a message, wherein such part equals in size to a message.

12. Method according to claim 11, wherein the program of instructions is executed when a receiver-device has a communication channel with a media server at the time when a media server receives a data-set from a sender-device.

13. Method according to claim 11, wherein the program of instructions is executed when a receiver-device establishes a communication channel with a media server.

14. Method according to claim 11, wherein prior to encrypting a transmitted message, a check-sum of a transmitted data-set is calculated using a hash function, wherein the variable is at least one of: unencrypted message data, and an identifier of a sender-device.

15. Method according to claim 11, wherein at least some data-set received from a media server contains a check-sum that is a result of performing a hash operation, wherein the variable is unencrypted message data and an identifier of a sender-device.
